(19) United States
(12) Patent Application Publication
(10) Pub. No.: US 2009/0099313 A1
(43) Pub. Date: Apr. 16, 2009

(54) POLY(HYDROXYALKANOIC ACID) AND THERMOFORMED ARTICLES

(75) Inventor: Julius Uradnisheck, Glen Mills, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. DU PONT DE NEMOURS AND COMPANY, Wilmington, DE (US)

(21) Appl. No.: 12/245,206

(22) Filed: Oct. 3, 2008

Related U.S. Application Data
(60) Provisional application No. 60/978,944, filed on Oct. 10, 2007.

(51) Int. Cl. C08L 33/02

(52) U.S. Cl. 525/221

(57) ABSTRACT

Disclosed is an article comprising a composition which comprises, consists essentially of, or consists of poly(hydroxyalkanoic acid) and a nucleator wherein the article is a two-dimensional article having a surface area to thickness ratio greater than about 200:1 length units. Also disclosed is a process which comprises contacting the composition with a nucleator to produce a compound; thermoforming in a heated mold to produce a thermoformed article; holding the article in the heated mold for about 1 to about 20 seconds; and recovering the article.

This application claims priority to US provisional application, Ser. No. 60/978944, filed Oct. 10, 2007, the entire disclosure of which is incorporated herein by reference.

The invention relates to a composition comprising poly(hydroxyalkanoic acid) and a carboxylic acid derivative, to a process for increasing crystallization of the composition, and to an article comprising the composition.

### BACKGROUND OF THE INVENTION

Poly(hydroxyalkanoic acid) (PHA) such as polylactic acid (PLA) is a resin comprising renewable monomer such as production by bacterial fermentation processes or isolated from plant matter that include corn, sugar beets, or sweet potatoes. The resin can be used for thermoformed packaging articles such as cups, trays, and clam shells. Generally, the resin is first extruded into an amorphous sheet and formed at about 90-100° C. into finished articles.

The unoriented sections of the articles do not fully crystallize because many PLA grades crystallize too slowly in high speed thermoforming equipment or crystallize with less than 10% crystallinity. As PLA grades popular for thermoforming have a glass transition temperature (Tg) of 55° C., articles of such PLA that are thermoformed into cool molds have poor dimensional stabilities when heated above the Tg. A thermoformed or stretched article may shrink in a few seconds more than 5% (sometimes 50%) when heated above the Tg. The tendency for shrinkage is especially high (to 50%) in those parts of molded articles that experience a critical amount of orientation between about 25% (final length or area is 25% greater than the pre-formed length or area) and about 100%. Those regions having higher than about 100% orientation may experience some strain-induced crystallization and additional crystallization if held constrained above their Tg thereby having shrinkages as low as 10% at temperatures slightly above Tg. Those areas having no orientation have low shrinkages (<10%); however, these areas are soft and easily deform at temperatures slightly above Tg. Those regions in between 100% and 25% have the highest shrinkage which is the subject of this application. High forces can be generated by shrinkage and therefore the shrinkage of one region in a complex hollow article can be magnified into a larger dimensional effect on the structure. Therefore for the purpose of this application the desirable shrinkage is less than 8%, less than 4%, or less than 1%.

The shrinkage force is due to the presence of stretched PLA molecules not crystallized and amorphous but frozen in place by the rapid cooling in the mold, termed “amorphous orientation”. When the temperature rises above Tg these molecules relax rapidly and induce or cause shrinkage if the article is not constrained from shrinking. Some additional shrinkage in a few minutes can arise from crystallization if the PLA is a particularly fast crystallizing PLA due to its low molecular weight (such as below 10,000 g/mole), low D-lactide (meso-lactide) content, and/or use of high amounts of special nucleators and/or if the temperature rises to half way between Tg and the melt point, the point of most rapid crystallization.

To solve the problems, one may increase crystallinity or decrease amorphous orientation. A numerical ratio therefore to be minimized is the amount of amorphous orientation versus total crystallinity. Such a ratio, which can be defined by x-ray, is the ratio of amorphous orientation determined by x-ray to total crystallinity determined by x-ray should be less than about 2 or preferably less than about 1 or more preferably less than about 0.1

There are several methods for minimizing the ratio of amorphous orientation. For example, to increase the crystallinity of a PHA having a Tg of 55° C. and a melt point of 155° C., one may heat-treat the finished molded article at 110° C. for several minutes to avoid the shrinkage when heated above 55° C. However, doing so may cause the article to shrink in the first few seconds of the heat treatment.

One may heat-treat the article for several seconds at about 110° C. or slightly higher while it is constrained from moving in the mold. Doing so would leave as amorphous those regions of the article that have not been oriented more than about 25%. Removal of the article from the hot mold would cause deformation of those regions.

One may heat-treat the article for several minutes at about 110° C. while it is constrained from moving in the mold. Doing so would extend the thermoforming cycle time too much.

Alternatively, one may reduce the original amount of amorphous orientation, by molding an article at a high temperature, above the half-way temperature between Tg and melt point. Excessively high temperatures, such as approaching the melt point, would give excessive sagging of the hot sheet or deformation at its supports. Slightly lower excessive temperatures could be problematical due to exudation of oligomer or additives on the surface of the mold giving surface roughness to the molded article. Running at high temperatures (not excessive) gives a molded article having no stretched amorphous PLA molecules and gives reduced shrinkage compared with a molded article having stretched amorphous molecules and 90% or more amorphous content. However, the article will be 90% or more amorphous, which is very soft and deforms easily above the Tg, while an article of >10% crystalline is generally desired. A 100% amorphous article may also experience some shrinkage when held for weeks at temperatures above 55° C. due to some beginnings of crystallization or other molecular re-arrangement.

One may mold an article at high temperature and anneal the article in the molds at a temperature half way between Tg and the melt point to increase the crystallinity but doing so may greatly increase the haziness of the article.

Alternatively an article can be made such that the resin is stretched during thermoforming to more than about 150% and heat treated for a few seconds at half way between Tg and melting point. Doing so may give clarity and dimensional stability due to strain-induced crystallization process, but this large amount of stretching limits the shape of molded articles to those that are very long and narrow.

One may also increase the crystallinity or rate of crystallization by use of a nucleator for PLA. Nucleators include talc, calcium silicate, sodium benzoate, calcium titanate, boron nitride, copper phthalocyanine, and isotactic polypropylene. Using nucleator introduces haze or opacity to the otherwise transparent PLA articles thereby impairing the value of the articles. See, e.g., U.S. Pat. No. 6,114,495, U.S. Pat. No. 6,417,294, and WO 03014224.

Therefore, there is a need to produce a clear article from PHA and to increase the dimensional stability throughout the surface of the clear article.

### SUMMARY OF THE INVENTION

An article comprises or is produced from a composition comprising poly(hydroxyalkanoic acid) (PHA) and 0 to about 4%, based on the weight of the composition, of a nucleator wherein the article is optionally a thermoformed two-dimensional article optionally having a surface area to thickness ratio greater than about 1000:1 inches or at least 10% crystallinity.

A process comprises contacting a crystallizable PHA composition or PHA with a nucleator to produce a compound; thermoforming the compound in a heated mold at a temperature of from about 15° C. below the average of glass transition temperature (T_{g}) and melting point (Tmelt), of the PHA, to about 20° C. above the average of T_{g} and Tmelt to produce a thermoformed article; heat setting the article by holding the article in the heated mold; recovering the thermoformed article.

### DETAILED DESCRIPTION OF THE INVENTION

“Amorphous” means a sample of PHA that, when heated in a Differential Scanning Calorimeter (DSC) from ambient to 25° C. above its melting point at about 10° C./minute, shows less than about 1 J/g when the melting endotherm “J/g” is subtracted by the crystallization exotherm “J/g”. A fast crystallizing PHA is one that, when amorphous and is heated in the DSC, develops >5 J/g in the crystallization exotherm and especially >20 J/g. A slow crystallizing PHA is one that when amorphous and is heated in the DSC develops >1 J/g and <5 J/g of crystallization exotherm.

PHA compositions include polymers comprising repeat units derived from one or more hydroxyalkanoic acids having 2 to 15, 2 to 10, 2 to 7, or 2 to 5, carbon atoms. Examples include glycolic acid, lactic acid, 3-hydroxypropionate, 2-hydroxybutyrate, 3-hydroxybutyrate, 4-hydroxybutyrate, 3-hydroxyvalerate, 4-hydroxyvalerate, 5-hydroxyvalerate, 6-hydroxyhexanoic acid, 3-hydroxyhexanoic acid, 4-hydroxyhexanoic acid, 3-hydroxyheptanoic acid, or combinations of two or more thereof. Examples of polymers include poly(glycolic acid) (PGA), poly(lactic acid) (PLA) and poly(hydroxybutyrate) (PHB), polycaprolactone (PCL), or combinations of two or more thereof, including blends of two or more PHA polymers (e.g., blend of PHB and PCL) that are desirably not amorphous.

PHA can be produced by bulk polymerization. A PHA may be synthesized through the dehydration-polycondensation of the hydroxyalkanoic acid. A PHA may also be synthesized through the dealcoholization-polycondensation of an alkyl ester of polyglycolic acid or by ring-opening polymerization of a cyclic derivative such as the corresponding lactone or cyclic dimeric ester. The bulk polymerization can be carried out by two production processes, i.e., a continuous process and a batch process. JP03-502115A discloses a process wherein bulk polymerization for cyclic esters is carried out in a twin-screw extruder. JP07-26001A discloses a process for the polymerization for biodegradable polymers, wherein a bimolecular cyclic ester of hydroxycarboxylic acid and one or more lactones are continuously fed to a continuous reaction apparatus having a static mixer for ring-opening polymerization. JP07-53684A discloses a process for the continuous polymerization for aliphatic polyesters, wherein a cyclic dimer of hydroxycarboxylic acid is fed together with a catalyst to an initial polymerization step, and then continuously fed to a subsequent polymerization step built up of a multiple screw kneader. U.S. Pat. No. 2,668,162 and U.S. Pat. No. 3,297,033 disclose batch processes.

PHA also includes copolymers comprising more than one PHA, such as polyhydroxybutyrate-hydroxyvalerate (PHBN) copolymers and copolymers of glycolic acid and lactic acid (PGA/LA). Copolymers can be produced by copolymerization of a polyhydroxyalkanoic acid or derivative with one or more cyclic esters and/or dimeric cyclic esters. Such comonomers include glycolide (1,4-dioxane-2,5-dione), dimeric cyclic ester of glycolic acid, lactide (3,6-dimethyl-1,4-dioxane-2,5-dione), α,α-dimethyl-β-propiolactone, cyclic ester of 2,2-dimethyl-3-hydroxypropanoic acid, β-butyrolactone, cyclic ester of 3-hydroxybutyric acid, δ-valerolactone, cyclic ester of 5-hydroxypentanoic acid, ε-caprolactone, cyclic ester of 6-hydroxyhexanoic acid, and lactone of its methyl substituted derivatives, such as 2-methyl-6-hydroxyhexanoic acid, 3-methyl-6-hydroxyhexanoic acid, 4-methyl-6-hydroxyhexanoic acid, 3,3,5-trimethyl-6-hydroxyhexanoic acid, etc., cyclic ester of 12-hydroxy-dodecanoic acid, and 2-p-dioxanone, cyclic ester of 2-(2-hydroxyethyl)-glycolic acid, or combinations of two or more thereof.

PHA compositions also include copolymers of one or more PHA monomers or derivatives with other comonomers, including aliphatic and aromatic diacid and diol monomers such as succinic acid, adipic acid, and terephthalic acid and ethylene glycol, 1,3-propanediol, and 1,4-butanediol. About 100 different comonomers have been incorporated into PHA polymers. Generally, copolymers having the more moles of comonomer(s) incorporated, the less likely the resulting copolymer is to crystallize. If the copolymer does not crystallize when precipitated out of its soluble solution in some organic solvent, it cannot not crystallize when it is melt-blended with a nucleator.

PHA polymers and copolymers may also be made by living organisms or isolated from plant matter. Numerous microorganisms have the ability to accumulate intracellular reserves of PHA polymers. For example, copolymer poly(3-hydroxybutyrate-co-3-hydroxyvalerate) (PHB/V) has been produced by fermentation of the bacterium Ralstonia eutropha. Fermentation and recovery processes for other PHA types have also been developed using a range of bacteria including Azotobacter, Alcaligenes latus, Comamonas testosterone and genetically engineered E. coli and Klebsiella. U.S. Pat. No. 6,323,010 discloses a number of PHA copolymers prepared from genetically modified organisms.

Glycolic acid is derived from sugar cane. Poly(glycolic acid) can be synthesized by the ring-opening polymerization of glycolide and is sometimes referred to as poly-glycolide.

PLA includes poly(lactic acid) homopolymers and copolymers of lactic acid and other monomers containing at least 50 mole % (50% comonomer gives the least likely copolymer composition to crystallize, no matter what conditions) of repeat units derived from lactic acid or its derivatives (mixtures thereof) having a number average molecular weight of 3000 to 1000000, 10000 to 700000, or 20000 to 300000. PLA may contain at least 70 mole % of repeat units derived from (e.g. made by) lactic acid or its derivatives. The lactic acid monomer for PLA homopolymers and copolymers can be derived from d-lactic acid, I-lactic acid, or combinations thereof. A combination of two or more PLA polymers can be used. PLA may be produced by catalyzed ring-opening polymerization of the dimeric cyclic ester of lactic acid, which is frequently referred to as “lactide.” As a result, PLA is also referred to as “polylactide”.

PLA also includes the special class of copolymers and blends of different stereo-isomers of lactic acid or lactide. Melt blends of PLA polymerized from d-lactic acid or d-lactide and PLA polymerized from I-lactic acid or I-lactide can give a stereo-complex between the two stereopure PLAs at a 50/50 ratio. Crystals of the stereo-complex itself has a much higher melt point than either of the two PLA ingredients. Similarly stereo-block PLA can be solid state polymerized from low molecular weight stereo-complex PLA.

Copolymers of lactic acid are typically prepared by catalyzed copolymerization of lactic acid, lactide or another lactic acid derivative with one or more cyclic esters and/or dimeric cyclic esters as described above.

PHA may comprise up to about 99.8 weight %, of the composition, based on the total amount of PHA and nucleator used. For example, the PHA may be present in a range from a lower limit of about 96 to 100 weight %.

The PHA composition may comprises 0 to about 4%, about 0.1 to about 4%, about 0.5 to about 4%, about 1 to about 4%, about 1 to about 3%, about 0.5 to about 3%, or about 1 to about 2%, based on the weight of the composition, of a nucleator, which can include a carboxylic acid or its derivative that does not cause PHA depolymerization. The carboxylic acid or its derivative can include aromatic carboxylic acid (e.g., benzoic acid); aliphatic carboxylic acid (e.g., unsaturated fatty acid such as oleic acid; saturated fatty acid such as stearic acid and behenic acid; fatty acid alcohol such as stearyl alcohol; fatty acid ester such as butyl stearate; and fatty acid amide such as stearamide; behenamide); polycarboxylic acid; aliphatic hydroxycarboxylic acid; or combinations of two or more thereof. Wishing not to be bound by theory, film or sheet made from a PHA composition comprising fatty acid derivatives or long chain (e.g., ≧31 carbons) may be less optically clear due to possible difficultly in dispersing these compounds or due to less solubility of these compounds in PHA and due to a mismatch of refractive indices of the PHA and additives.

The carboxylic acids can be aliphatic, mono-functional (saturated, unsaturated, or multi-unsaturated) carboxylic acids thereof. The acid may have from about 10 to about 30, about 12 to about 28, about 16 to about 26, or 18 to 22, carbon atoms per molecule. Of particular interest are the acids that are on the US Food and Drug Administration (FDA) list as GRAS (generally regarded as safe). Examples of non-official GRAS acids include some mono- and some poly-carboxylic acids such as lactic acid, linoleic acid, malic acid, propionic acid, stearic acid, succinic acid, tannic acid, tartaric acid, or combinations of two or more thereof.

The carboxylic acids may have a low volatility (do not volatilize at temperatures of melt blending with PHA) when being melt-blended with PHA or have particles that can well disperse in PHA such as those having diameters less than about 2μ or are non-migratory (do not bloom to the surface of PLA under normal storage conditions (ambient temperatures)). That is, a desired carboxylic acid has a boiling point higher than the melt processing temperature and pressure of PHA, which is disclosed elsewhere in the application. Examples of carboxylic acids include lauric acid, palmitic acid, stearic acid, behenic acid, erucic acid, oleic acid, linoleic acid, or combinations of two or more thereof.

The composition may further comprise at least one optional cationic catalyst. Such catalysts are described in US4912167 and are sources of catalytic cations such as Al³⁺, Cd²⁺, Co²⁺, Cu²⁺, Fe²⁺, In³⁺, Mn²⁺, Nd³⁺, Sb³⁺, Sn²⁺, and Zn²⁺. Suitable catalysts include, but are not limited to, salts of hydrocarbon mono-, di-, or poly-carboxylic acids, such as acetic acid and stearic acid. Inorganic salts such as carbonates may also be used. Examples of catalysts include, but are not limited to, stannous octanoate, zinc stearate, zinc carbonate, and zinc diacetate (hydrated or anhydrous). When used, the cationic catalyst may comprise about 0.01 to about 3 parts by weight per hundred parts by weight of PHA and impact modifier.

The composition can also include, by weight of the composition, about 0.01 to about 30, about 0.1 to about 20, or about 0.2 to about 10%, a toughening agent such as an ethylene copolymer, a core-shell polymer, or combinations thereof.

An ethylene copolymer may comprise repeat units derived from (a) ethylene; (b) one or more olefins of the formula CH₂═C(R³)CO₂R⁴, where R³ is hydrogen or an alkyl group with 1 to 6 carbon atoms, such as methyl, and R⁴ is glycidyl; and optionally (c) one or more olefins of the formula CH₂═C(R¹)CO₂R², or carbon monoxide where R¹ is hydrogen or an alkyl group with 1 to 8 carbon atoms and R² is an alkyl group with 1 to 8 carbon atoms, such as methyl, ethyl, or butyl. Repeat units derived from monomer (a) may comprise, based on the copolymer weight, from about 20, 40 or 50% to about 80, 90 or 95%. Repeat units derived from monomer (b) may comprise, based on the copolymer weight, from about 0.5, 2 or 3% to about 17, 20, or 25%. An example of the ethylene copolymer derived from ethylene and glycidyl methacrylate and is referred to as EGMA. Optional monomers (c) can be butyl acrylates or CO. One or more of n-butyl acrylate, tert-butyl acrylate, iso-butyl acrylate, and sec-butyl acrylate may be used. An ethylene copolymer example is derived from ethylene, butyl acrylate, and glycidyl methacrylate (EBAGMA). Repeat units derived from monomer (c), when present, may comprise, based on the copolymer weight, from about 3, 15 or 20% to about 35, 40 or 70%.

If an ethylene copolymer is present in the composition, the carboxylic acid can be in the form of an alkyl ester or an alkyamide where the alkyl group has 4 to about 30 or 10 to about 20 carbon atoms.

A core/shell polymer may not comprise a vinyl aromatic comonomer, and have a refractive index not greater than 1.5; the core comprises one or more elastomers that may comprise polyalkyl acrylate and be optionally cross-linked; the shell comprises non-elastomeric polymer that may include polymethyl methacrylate and optionally contain functional groups including epoxy, carboxylic acid, or amine.

A core-shell polymer may be made up of multiple layers, prepared by a multi-stage, sequential polymerization technique of the type described in U.S. Pat. No. 4,180,529. Each successive stage is polymerized in the presence of the previously polymerized stages. Thus, each layer is polymerized as a layer on top of the immediately preceding stage.

A PHA composition can comprise one or more additives including plasticizers, stabilizers, antioxidants, ultraviolet ray absorbers, hydrolytic stabilizers, anti-static agents, dyes or pigments, fillers, fire-retardants, lubricants, reinforcing agents such as flakes, processing aids, antiblock agents, release agents, and/or combinations of two or more thereof.

These additives may be present in the compositions, by weight, from 0.01 to 7%, or 0.01 to 5%. For example, the compositions may contain from about 0.5 to about 5% plasticizer; from about 0.1 to about 5% antioxidants and stabilizers; from about 3 to about 20% other solid additives; from about 0.5 to about 10% nanocomposite; and/or from about 1 to about 20 weight % flame retardants. Examples of suitable other solid additives include pigments such as titanium oxide, microwave susceptors such as carbon or graphite, induction heated metals such as steel powder or transition metal oxide, and radio frequency heat-sealing sucseptors.

The article can have a surface area to thickness ratio greater than about 1000:1 inch (2540:1 cm) or>about 200:1 inch (504:1 cm) inch. The article can also have more than about 10%, 20%, 30%, or even 40% crystallinity (for example, PLA DSC method quantifies “30% crystallinity” as about 30 J/g melting endotherm for PLA when being heated from amorphous state at a rate of 10° C./minute); crystal lattice sizes smaller than about 500 nm or about 100 nm by Small Angle X-ray; and less than 1 for the ratio of amorphous-oriented PLA molecules.

A thermoforming process comprises contacting a PHA composition or PHA with a nucleator to produce a compound. The contacting can include mixing PHA and nucleator till the nucleator is substantially or even homogeneously dispersed. Any impact modifiers (e.g. ethylene-acrylate copolymers, ionomers, grafting agents) and additives may be also dispersed in the composition. Any mixing methods known in the art may be used. For example, the component materials may be mixed to substantially dispersed or homogeneous using a melt-mixer such as a single or twin-screw extruder, blender, Buss Kneader, double helix Atlantic mixer, Banbury mixer, roll mixer, etc., to give a resin composition.

The contacting can include a melt-mixing temperature in the range above the softening point of the PHA and below the depolymerization temperature of the PHA of about 100° C. to about 400° C., about 170° C. to about 300° C., or especially about 180° C. to about 230° C. at an ambient pressure or in the range of 0 to about 60 MPa or 0 to about 34 MPa. The condition creates sufficiently high shear history to disperse the nucleator into small particles and distribute them uniformly through the melted PHA and sufficiently low shear history to avoid excessive loss of PHA molecular weight and its embrittlement. Shear history is the concept of the amount to shear over a duration of time. A melt experiences more shear history when it experiences high shear for a long time than when it experiences high shear for a short time. Similarly a melt experiences more shear history when it experiences medium shear for a time than when it experiences very low shear for a long time. The shear history of plastics processing equipment may be complicated by differing shear rates and duration times within the equipment for example in a size screw extruder producing pellets the screw has low shear rates and long durations within the channels of the screw but high screws rates and low durations between the screw and the walls of the extruder. In general insufficiently high shear history is achieved by use of less than about 2 minutes of mixing from introduce of the ambient temperature ingredients into a heated batch twin blend mixer using rotor blade mixer that may be co- or counter-rotating or the use of at less than 10:1 length to diameter ratio trilobal, co-rotating twin screw extruder using a screw that contains less than 10% length of screw elements that are either kneading blocks or reverse elements, the rest being forward conveying sections. For example, a sufficiently high shear history can result from use of at least 3 minutes on the batch unit and at least 20:1 L:D (length to diameter) ratio on the continuous unit and an excessively high shear history may result from more than 40 minutes in the batch unit or a 50:1 L:D ratio in the continuous unit. Other processing equipment can be used for melt mixing such as a single screw extruder, counter rotating twin screw extruder, or roll mill. Also useful processors may include bilobal twin screw extruders and single screw extruders with mixing torpedoes at the end of the screw. The carboxylic acid may be present in a sufficiently high or >0.5% crystallization-improving amount thereby providing heat resistance at 55° C. or above. Not to be bound by theory, if the carboxylic acid is present at too high a level, it may cause the melt blend viscosity and melt strength to be too low for subsequence processing into pellets, sheeting, or thermoformed articles. For example, whereas pellets of a concentrate of carboxylic acid in PHA may be formed via under-water pelletization if the nucleator additive level is less than about 50%, amorphous sheeting requires that level to be less than about 10% for sufficiently high melt strength. Furthermore the size of nucleator particles having unmatched refractive indexes with the PHA may be less than about 500 nm, less than about 300 nm, or even less than 80 nm for low haze. The difficulty of dispersing nucleator to small sizes may increase with amount of nucleator used and its solubility in the PHA. In general more than about 2% nucleator in the PHA may lead to hazy blends. For example, more than 3% or more than about 5% may give too high a level of haze irrespective of the type of mixing used.

Alternatively, a portion of the component materials can be mixed in a melt-mixer, and the rest of the component materials subsequently added and further melt-mixed until substantially dispersed or homogeneous. The resulting composition is a concentrate of carboxylic acid in PHA and can comprise, by weight of the composition, 50 to 90 or 60 to 70% PHA and 10 to 50 or 30 to 40% of carboxylic acid such as stearic acid.

The composition may be molded into articles using any melt-processing technique suitable for PHA provided the processing into the finished article is done in a manner to achieve low haze with high crystallinity. Commonly used melt-molding methods known in the art to achieve low haze and crystallinity can include injection molding followed by blow molding, profile extrusion molding with stretching, or extrusion blow molding. The compositions also may be melt-formed into films by extrusion or calendaring to prepare amorphous cast film. Those cast film that are amorphous may be further thermoformed into articles and structures.

The compositions may also be used to form films, rods, profiles, sheets, fibers and filaments that may be unoriented and crystalline and having haze, or unoriented and amorphous semifinished articles, or oriented from the melt such as blown film or at a later stage oriented by heating a nearly amorphous semifinished article such as by injection stretch blown molding or thermoforming.

The compositions may be formed into films or sheets by extrusion through either slot dies to prepare cast films or sheets or annular dies to prepare blown films or sheets followed by thermoforming into articles and structures that are oriented from the melt or at a later stage in the processing of the composition.

To achieve the full benefit clarity and thermal benefit of the nucleator, the making of any amorphous semi-finished article desirably avoid excessive crystallinity and the making of the finished article desirably avoid both insufficient crystallinity and excessively large crystals of PHA for those parts of the article valuing transparency. To avoid excessive crystallinity which may inhibit subsequent forming or stretching of articles and/or introduces large hazy crystals, the making of amorphous sheet or articles of PHA involves using melted PHA more than 20° C. above the peak melting point to provide a controlled or consistent amount of nucleator by avoiding fortuitous nucleators.

The composition can then be thermoformed in a heated mold at a temperature of from about 50° C. to about 140° C., about 60° C. to about 120° C., about 65° C. to about 100° C., or about 65° C. to about 90° C., to produce a thermoformed article. The mold can be any mold known to one skilled in the art such as trays, cup, cap, bowl, or lid. For example, a mold can be made with aluminum and can be used for stretching (orientation) by application of vacuum from inside the mold to a heated sheet of PHA covering the top of the mold. Upon completion, the thermoformed article, especially the one where the PHA is modified with a nucleator, can be held in the heated mold for additional about 1 to about 20 seconds, about 1 to about 15 seconds, about 1 to about 10 seconds, about 1 to about 5 seconds, or about 2 to about 4 seconds heat set the molded article.

Wishing not to be bound by theory, the mold temperature is higher than the polymer's Tg, or the molecules would not move no matter how long in the mold. Lowering the temperature increases the required time. For example, for a PHA having a Tg of 55° C. and a melting point of 150° C., holding at 80° C. for even 30 seconds may produce high shrinkage. Accordingly, the mold temperature is desirably higher than 15° C. below halfway between T_{g} and Tₘₑₗₜ (temperature at which the polymer melts) so that the time in the mold is short. The mold temperature may also be lower than about 15° C. above halfway between T_{g} and Tₘₑₗₜ so that the article is not deformed when removed from the mold. The absolute top temperature would be Tₘₑₗₜ. The molded article accordingly can be heat set at a temperature higher than about 15° C. below halfway between T_{g} and Tₘₑₗₜ such as about 90° C. to about 135° C., 95° C. to about 120° C., 95° C. to about 110° C., about 100° C., about 110° C., about 120° C., or about 135° C. for about 1 to about 30 seconds, about 1 to about 20 seconds, about 1 to about 15 seconds, about 1 to about 10 seconds, about 1 to about 5 seconds, or about 2 to about 4 seconds.

The resulting article can then be cooled rapidly to the Tg. For thick profiles, the cooling rate of the interior of the profile may be benefited by use of the coldest temperature practical on the exterior of the article. That temperature is desirably below the glass transition temperature of the PHA. For example, for PHA having a glass transition temperature of about 50° C. and sheeting thickness of about 700μ may benefit from using one-side quenching temperatures of 10° C. whereas 500μ sheet can be made amorphous using 20° C. one-sided quench conditions. Quench temperatures above about 40° C. may not be as useful because the melt contacting such surfaces can cool too slowly and/or stink to such surfaces if the glass transition temperature is about 40° C. The exact minimum temperature may decrease when a PHA is used that is inherently slower at crystallizing or when a lower amount of nucleator is used or when the article is cooled or quenched from all sides versus one side or when the Tg of the PHA is lower.

In processing the amorphous semi-finished article into a transparent and crystallized sheet, the amorphous article may be first heated by conductive, convective, or radiative heating. With radiative heating, the article is exposed to black-body radiation temperatures ranging from 200° C. to about 700° C. Time in a 230° C. black body radiator may range from about 10 seconds to about 70 seconds, or from 20 seconds to 60 seconds, or 30 seconds to 50 seconds for a 600μ thick profile heated from both sides. The optimal temperature for the semi-finished article for achieving crystallinity and clarity in the next step is about half way between the glass transition and the melt point for the particular PHA used.

In forming the heated amorphous semifinished article into a finished transparent, crystalline article the semi-finished article may be stretched at sufficiently high speeds and high stretch ratios to cause crystallization and to enable those crystallites to be small enough to not cause haze. X-ray is used to measure size of the crystallites. For low haze the crystallites size of PLA or PHA should be less than about 1000 nm or preferably less than about 100 nm or more preferably less than about 50 nm. Stretch rate may be about 10% to about 1000% per second, or between 20% per second and 600% per second. Stretch ratios may be about 20% (post stretch length is 150% of the pre-stretched dimension) to about 800%, or 50% to 700%, or 100% to 300%. Not wishing to be bound by theory, slow stretch rates may give haze or incompletely formed articles and too high stretch rates may give insufficiently high crystallinity resulting in finished articles which have poor dimensional stability above the glass transition temperature. Low stretch ratios may not induce enough crystallinity within the short time of the thermoforming process or cause haze in the finished article and too high a stretch ratio may cause excessive thinning or tearing of the article. The exact stretch ratio may be higher for unbalanced or one-dimensional stretching or articles which not cooled during the stretching operation such as is the case for vacuum, pressure-assisted, or no physical “plug assistance”. Otherwise those parts of the article that are cooled during the stretch operation may experience haze or poor dimensional stability.

The film may be a single layer of the PHA composition (a monolayer sheet) or a multilayer film or sheet comprising a layer of the PHA composition and at least one additional layer comprising a different material.

For packaging applications, a multilayer film may involve three or more layers including an outermost structural or abuse layer, an inner or interior barrier layer, and an innermost layer making contact with and compatible with the intended contents of the package and capable of forming any needed seals. Other layers may also be present to serve as adhesive layers to help bond these layers together. The thickness of each layer can range from about 10 to about 200 μm.

The outermost structural or abuse layer may be prepared from the PHA composition. Additional structure layers may include oriented polyester or oriented polypropylene, but can also include oriented polyamide (nylon). The structure layer can be printed, for example, by reverse printing using rotogravure methods.

The inner layer can include one or more barrier layers to reduce the permeation rate through the layer by agents such as water, oxygen, carbon dioxide, electromagnetic radiation such as ultraviolet radiation, and methanol that potentially can affect the product inside therein. Barrier layers can comprise, for example, metallized polypropylene or polyethylene terephthalate, ethylene vinyl alcohol, polyvinyl alcohol, polyvinylidene chloride, aluminum foil located so as not to interfere with the optical value of the PHA such as to read-through to the print layer, silicon oxides (SiOx), aluminum oxide, aromatic nylon, blends or composites of the same as well as related copolymers thereof.

The innermost layer of the package can be the sealant and can be a polymer layer or coating that can be bonded to itself (sealed) or other film or substrate at temperatures substantially below the melting temperature of the outermost layer. Sealants are well known and can be commercially available from E. I. du Pont de Nemours and Company (DuPont), Wilmington, Del. Substrate can include foil, paper or nonwoven fibrous material.

A multilayer film can be produced by any methods well known to one skilled in the art such as, for example, coextrusion and can be laminated onto one or more other layers or substrates. Other suitable converting techniques are, for example, blown film (co)extrusion and extrusion coating.

Films can be used to prepare packaging materials such as containers, pouches and lidding, balloons, labels, tamper-evident bands, or engineering articles such as filaments, tapes and straps.

The disclosure uses film as example and is applicable to sheet, which is thicker than film.

The article can be in other forms such as shaped articles or molded articles. Containers and packaging materials can be of various shapes including trays, cups, caps, bowls, or lids prepared from sheets by vacuum or pressure forming. Other shapes include those prepared by deep drawing an unstretched sheet (i.e. thermoforming), by extrusion blow molding or biaxial stretching blowing parisons (injection stretch blow molding), by injection molding, compression molding or other molding processes; profile extruded articles; carton; squeezable tubes, pouches or bottles; components of containers; bags or pouches within a rigid container that dispense liquids such as wine, medical fluids, baby formula; clam shells, and blister packs.

The thermoformed article can be recovered by any methods known to one skilled in the art.

A film or sheet could be thermoformed to produce a concave surface such as a tray, cup, can, bucket, tub, box or bowl. Thermoformed articles may be combined with additional elements, such as a generally planar film sealed to the thermoformed article that serves as a lid (a lidding film).

Products that can be packaged include food and non-food items including beverages (e.g., carbonated beverages, orange juice, apple juice, grape juice, other fruit juices and milk), solid foods (e.g., meats, cheese, fish, poultry, nuts, coffee, applesauce or other sauces, stews, dried fruit, food paste, soups and soup concentrates and other edible items), spices, condiments (e.g., ketchup, mustard, and mayonnaise), pet food, cosmetics, personal care products (e.g., toothpaste, shaving foam, soaps, shampoos, lotions and the like), pharmaceuticals, fragrances, electronic components, industrial chemicals or household chemicals (e.g., laundry detergent, fabric softener), agrochemicals, medical devices and equipment, medicinal liquids, fuels, and biological substances.

Films may also be slit into narrow tapes and drawn further to provide slit film fibers for use as degradable sutures.

The following Examples are illustrative, and are not to be construed as limiting the scope of the invention.

### EXAMPLES

The example illustrates the invention in making thermoformed cups.

### Materials

PLA2002D pellets were purchased from NatureWorks LLC (Minnetonka, Minn. USA) and had a melt viscosity about 1500 Pa·s (190° C. and 100s⁻¹), a T_{g} of 55° C., a melt point maximum endotherm at 150° C., and crystallinity generated with a second 10° C./minute heating of pellets previously heated to complete melting at 250° C. and cooled to 20° C. of about 0.5 J/g.

PLA4032D pellets were also purchased from NatureWorks LLC and had a T_{g} of 58° C., a melt point maximum endotherm at 166° C., and crystallinity of about 6 J/g making it a faster crystallizing PLA then PLA2002D.

Stearic acid was obtained from Aldrich (Batch 11821LC) 95% pure.

Behenamide was Crodamide® BR available from Croda Inc, Edison, N.J.

Irgafos® 168 was obtained from Ciba Specialty Chemicals (Tarrytown, N.Y. USA).

EBAGMA was an autoclave-produced ethylene/n-butyl acrylate/glycidyl methacrylate terpolymer (monomer ratio 66.75 wt % ethylene, 28 wt % n-butyl acrylate, 5.25 wt % glycidyl methacrylate, melt index 12 dg/minute, 190° C., 2.16 kg load, melting range 50° C. to 80° C.).

### Analytical Equipment and Methods

Batch blending was accomplished on a Haake Rheocord 9000 using roller blade rotors and a 55 g mixing chamber operated by preheating the unit to goal melt temperature, then running rotors, starting the clock, charging about 55 g of ingredients within about a 15 second period, closing the lid, and recording the torque, time, and melt temperature. When complete the melt mass was discharged onto a cold container, cooled to ambient and sealed.

Continuous melt blending and amorphous sheet extrusion were accomplished on a Werner&Pfleiderer (W&P process) 28 mm trilobal twin screw extruder with coat hanger die and quench drum. The extruder used an 830 mm long screw. Pellets and additives entered about 70 mm from the top of the screw as a solid mixture at about 10 kg/hr to 20 kg/hr using a Foremost volumetric pellet feeder. The screw used forward conveying segments for most of its length and about 20% of its length used kneading blocks. The unit was run at 125 rpm with a melt temperature of 190° C. to 210° C. The melt passed through a coat hanger die (20 cm width and a 0.76 mm die gap). The melt curtain fell vertically about 5 cm to a quench drum cooled to 10° C. to 23° C. The drum rotation speed was set to minimum melt draw. Sheet thickness was controlled between about 250 micron and about 750 micron by varying the throughput rate of the polymer feed.

DSC was a TA Instruments (New Castle, Del.) Model Q1000 and operated on about 9 mg of sample with 10° C./minute heating from ambient to 250° C. (in the case of PLA melting at 150° C. to 180° C.). The first heat can generate a crystallization exotherm when the polymer crystallizes and at higher temperatures an exotherm is generated that is the polymer crystals melting. The “J/g” for the exotherm minus the “J/g” for the endotherm is an approximate measure of the amount of crystallinity in the original sample.

Shrinkage was measured as a percentage change in machine direction (stretch direction) length when an unconstrained sample was exposed to 60° C. water for 30 seconds.

Oriented and unoriented content of the amorphous and crystalline regions of samples was measured by x-ray. X-rays were produced by an x-ray generator (Phillips XRG 3100) operated at 30 kV and 30 mA, and a Cu x-ray tube. A Ni filter was used in front of a 3 inch length collimator, which had a 500 micron inner diameter; both of these measures improved the condition of the beam (monochromaticity and collimation). Radiation diffracted from the sample traveled to the detector through a flight path filled with helium. The flight path consisted of a conical metallic hollow chamber with apex towards the sample and base at the detector. Apex and base were covered by 0.25 mil Mylar windows. A 5mm beam stop was glued to the Mylar window at the base of the conical chamber, at the center of the detector. The sample to detector distance was 9 cm. The 2D wire detector was from Bruker (HiStar, square sensitive area, 107.8 mm side) and provided energy discrimination to improve sensitivity of CuK-alpha photons. Sensitivity and spatial calibrations were performed according to manufacturer's specifications, and these calibrations were used in the application of respective corrections by the data collection software (SAXS for WNT version 3.3). The Meridional intensity is a measure of un-oriented content. Equatorial intensity is a measure of oriented content. The sharper peak (scattering angle less than about 5 two-theta degrees) of the Meridional and Equatorial is a measure of the crystal content of the un-oriented and oriented content respectively. The broader peak (scattering angle of more than about 10 two-theta degrees) of the Meridional and Equatorial is a measure of the amorphous content of the un-oriented and oriented content respectively. Since the Equatorial intensity results contain in their base-line the Meridional results, the appropriate arithmetic is used. The fractional amount of oriented amorphous content is a ratio determined from the peak height intensities which occur at about 17 two-theta degrees. That ratio is:

R=J/(K+F) Where

J=amorphous oriented content=Equatorial height of the broad peak minus the baseline which is equal to about the Meridional narrow peak height;

K=crystalline oriented content=Equatorial height of the narrow peak minus the baseline which is the Equatorial height of the broad peak;

E=unoriented amorphous content=Meridional height of broad peak minus baseline; and

F=unoriented crystalline content=Meridional height of narrow peak minus baseline which is equal to about the height of the Meridional broad peak height.

Alternatively the ratio can be R=J/K.

Crystallite size was determined using the above-x-ray apparatus and method. The actual size calculation uses the Scherrer formula.

Nearly amorphous samples of PHA were prepared by the W&P process described above of the thicknesses shown in Table 1. Samples of about 1 cm by 1 cm were contacted on both sides by the platens of a press at 110° C. and with a pressure of less than 20 psi for 2 to 40 seconds (time uncertainty was 1 second) to avoid stretching of the samples. The samples were immediately (faster than about 0.5 seconds) removed and cooled to ambient. The amount of crystallinity developed was determined by DSC as described above (e.g. melting endotherm minus previous crystallization exotherm).

TABLE 1

| | Thickness | Heating | Crystallinity |
|---|---|---|---|
| Run¹ | (mil) | at 110° C. (sec) | after heating (J/g) |
| 156-17 | 21 | 0 | 2.6 |
| 156-17 | 21 | 10 | 2.2 |
| 156-17 | 21 | 20 | 2.9 |
| 156-17 | 21 | 40 | 6.2 |
| 156-9 | 21 | 0 | 2.5 |
| 156-9 | 21 | 2 | 11 |
| 156-9 | 21 | 5 | 3 |
| 156-9 | 21 | 20 | 11 |
| 156-9 | 21 | 40 | 16 |
| 28-1 | 31 | 0 | 0.1 |
| 28-1 | 31 | 10 | 1 |
| 28-1 | 31 | 20 | 1 |
| 28-1 | 31 | 40 | 0.4 |
| 28-2 | 30 | 0 | 2 |
| 28-2 | 30 | 10 | 0.1 |
| 28-2 | 30 | 20 | 1 |
| 28-2 | 30 | 40 | 0.1 |
| 28-4 | 30 | 0 | 16 |
| 28-4 | 30 | 10 | 15 |
| 28-4 | 30 | 20 | 18 |
| 28-4 | 30 | 40 | 21 |

¹The composition for runs 156-17 was PLA2002 + 1% stearic acid, for 156-9 was PLA2002D + 2% behenamide + 0.6% IRGAFOS168 + 2% EBAGMA, for 28-1 was 100% PLA4032D, no additive, for 28-2 was PLA4032V + 1% stearic acid, and for 28-4 was PLA4032D + 1% behenamide + 1% EBAGMA.

Table 1 shows that the crystallization of these unoriented PLA resins required more than about 40 seconds to develop an additional 15 J/g or more of crystallinity.

TABLE 2

| Run | Thickness (mil) | Composition |
|---|---|---|
| 28-1 | 31 | 100% PLA4032D, no additive |
| 28-2 | 30 | PLA4032D + 1% stearic acid |
| 28-4 | 30 | PLA4032D + 1% behenamide + 1% EBAGMA |
| 147-1 | 24 | 100% PLA2002D, no additive |
| 156-9 | 21 | PLA2002D + 2% behenamide + |
| | | 0.6% IRGAFOS168 + 2% EBAGMA |
| 156-17 | 21 | PLA2002D + 1% stearic |

Amorphous sheets of the above compositions were made using the W&P process described above; the sheets were about 12 inch wide. Along the transverse to flow direction, parallel inked lines were marked at intervals of 1-cm. The sheets were then cut to make about 1-inch wide strips. One end of the 1-inch strip of sample was taped away from where strip was to be heated (or with heat resistant tape). The mold included two (2) brass stretching plates (about 43 cm×43 cm) heated in a press to 110° C. A quench plate simulating cool the mold was maintained at about 22° C. Each sample was directly contacted with the two hot plates for 5-10 seconds. The top plate was removed and the sheet was stretched for about 2 seconds. The plates were immediately quenched at about 22° C. for about 10 seconds. The stretched samples were measured for stretch ratios by monitoring the change in the machine direction width from the original 1-cm width and dimensions. The samples were exposed to 60° C. and the shrinkage recorded. The results are shown in the Table 3 (“1×” means the original length was doubled during the stretch process and “2×” means the original length was tripled).

TABLE 3

| | | Crystallinity | Shrinkage |
|---|---|---|---|
| Run | Stretch | (J/g) | (%) |
| 28-1 | 1.1x | 2 | 24 |
| 28-1 | 2.3x | 22 | 28 |
| 28-2 | 1.4 | 9 | 19 |
| 28-2 | 3.7x | 28 | 28 |
| 147-1 | 1.4x | 1 | 17 |
| 147-1 | 3.7x | 5 | 35 |
| 147-1 | 0.5x | coming | 6 |
| 147-1 | 1x | coming | 17 |
| 156-9 | 1.4x | 11 | 13 |
| 156-9 | 2x | 16 | 12 |
| 156-17 | 4.6x | 19 | 25 |
| 28-4 | 1x | 20 | 10 |
| 28-4 | 2.5x | 27 | 3 |

Table 3 also shows that although the higher crystallinity was generated from the use of the nucleators, the faster crystallizing PLA, and the higher stretch ratios, the shrinkage was not lowered all the way to 0%. Table 3 also shows that within a wide range of stretch ratios, high crystallinity alone does not guarantee low shrinkage. Table 3 in combination with Table 1 also shows that a stretching process is required to achieve crystallinity in short time periods such as 2 seconds.

In a separate run, sheets were oriented and quenched as above except a next step of heat setting was applied to the sheets. For heat setting, the sheets were constrained from shrinking in the direction of their stretch and then exposed to 100° C. for specific time periods. These sheets were then quenched to 22° C. Their crystallinity (J/g) and shrinkage (%) are shown in Table 4.

TABLE 4

| | | Heat Set Time | | | | | |
|---|---|---|---|---|---|---|---|
| | | 10 seconds | | 20 seconds | | 40 seconds | |
| Run | Stretch | Crystallinity | Shrinkage | Crystallinity | Shrinkage | Crystallinity | Shrinkage |
| 28-1 | 1.1x | — | — | — | 20 | 6 | 12 |
| 28-1 | 2.3x | 32 | 0 | 34 | 0 | — | — |
| 28-2 | 1.4 | 7 | 33 | 3 | 20 | — | — |
| 28-2 | 3.7x | 25 | 3 | 43 | 3 | — | — |
| 147-1 | 1.4x | — | — | 0 | 20 | 1 | 20 |
| 147-1 | 3.7x | — | — | 5 | 27 | 17 | 27 |
| 156-9 | 1.4x | 14 | 13 | 14 | 10 | — | — |
| 156-9 | 2x | 18 | 13 | 22 | 0 | — | — |
| 156-17 | 4.6x | 19 | 10 | 20 | 3 | — | — |

Table 4 shows that heat setting at 100° C. was effective at reducing the shrinkage especially for samples oriented above 2× and when nucleation is present. Heat setting for longer than 10 seconds gave shrinkages approaching 0%.

Although higher orientation above 3× tend to give lower shrinkages, the geometry of thermoformed cups, trays, and clamshells generates regions well below 3× such as the base of the article. In another run, samples were oriented about 2× using a variety of orientation temperatures. The films were quenched and not heat-set and the shrinkages were measured as shown in Table 5.

TABLE 5

| | | Stretch Temp | Crystallinity | Shrinkage |
|---|---|---|---|---|
| Run | Stretch | (° C.) | (J/g) | (%) |
| 147-1 | 1x | 80 | 0 | 48 |
| 156-9 | 1.3x | 80 | 6 | 53 |
| 156-17 | 1.5x | 80 | 8 | 50 |
| 156-9 | 0.9x | 65 | 8 | 48 |
| 147-1 | 0.9x | 65 | 4 | 48 |
| 156-9 | 1.1x | 130 | 7 | 6 |
| 147-1 | 0.9x | 130 | 1 | 5 |

Table 5 shows that, without heat setting, even with nucleators and a fast crystallizing PLA (Table 3), the shrinkage could not be lowered toward 0% by adjusting forming temperature alone. The result also shows that higher temperature orientation was beneficial for lower shrinkage but crystallinity of the sample was low.

The heat setting durations of longer than 20 seconds (as exemplified in Table 4) are impractically long for commercial thermoforming operations. In a continuation of the above run, samples were heat set at slightly below 100° C. for various time durations between 5 and 90 seconds. The resulting samples were tested for 60° C. shrinkage.

TABLE 6

| | | Stretch Temp | | | |
|---|---|---|---|---|---|
| Run | Stretch | (° C.) | Time¹ | Time¹ | Crystallinity² |
| 147-1 | 0.9x | 80 | 20/23% | 40/7% | 9 |
| 156-9 | 1.1x | 80 | 5/3% | 21/0% | 21 |
| 156-17 | 1.2x | 80 | 5/20% | 20/0% | 17 |
| 156-9 | 1.0x | 65 | 5/13% | 10/0% | 17 |
| 147-1 | 0.9x | 65 | 9/13% | 40/13% | 2 |
| 156-9 | 1.1x | 130 | 10/3% | 19/0% | 16 |
| 147-1 | 0.9x | 130 | 40/7% | 90/5% | 0 |

¹Heat set duration (seconds)/Shrinkage %.
²For sample of heat set in adjacent column (J/g).

Table 6 shows that even slower-crystallizing PLA2002D could be heat-set to 0% shrinkage when nucleated using short heat set durations at 100° C. if orientation is not conducted at too high a temperature. A mold temperature slightly below 100° C. is a convenient heat setting temperature because it involves running hot water through the molds instead of either water/glycol mixtures or the use of pressured hotter water. Additional heat setting tests were run below 100° C. and various durations. The samples were tested for shrinkage at 60° C. and the results are shown in Table 7.

TABLE 7

| | | Stretch | | | |
|---|---|---|---|---|---|
| | | Temp | Heat Set | Heat Set | |
| Run | Stretch | (° C.) | Temp (° C.) | Time (second) | Shrinkage (%) |
| 156-9 | 0.9x | 80 | 61 | 60 | 48 |
| 156-9 | 1x | 80 | 70 | 40 | 37 |
| 156-9 | 1x | 80 | 80 | 30 | 23 |
| 156-9 | 1.1x | 130 | 80 | 10 | 6 |
| 156-9 | 1x | 80 | 80 | 10 | 27 |

Table 6 shows that at higher heat setting temperatures (lower than 150° C. below the average of T_{g} and Tₘₑₗₜ) achieved low shrinkage was not achieved within 30 seconds.

Table 7 shows that at higher heat setting temperatures cooler than 15° C. below the average of T_{g} and Tₘₑₗₜ) does not generate an article that is of low shrinkage and high crystallinity with less than about 30 seconds of heat setting time.

In another run amorphous sheets were oriented at 110° C. as described above except instead of quenching the sample, the sheet was held fixed under constraint just above but not touching the quench plate. Then the sheet was quenched rapidly to about 22° C. The shrinkage of the resulting sheet was measured.

TABLE 8

| | | | Shrinkage |
|---|---|---|---|
| Run | Stretch | Delay Time Before Quenching (second) | (%) |
| 147-1 | 2x | 0 | 29 |
| 147-1 | 1.5x | 2 | 20 |
| 147-1 | 2x | 5 | 23 |
| 147-1 | 2x | 10 | 10 |
| 156-9 | 3.7x | 2 | 0 |
| 156-9 | 3.7x | 5 | 0 |

One method to allow molecular relaxation for low shrinkage was to heat set the formed article in a hot mold. Table 8 shows that another method for low shrinkage would be to suspend the still hot formed article in the cool mold but not touching the walls of the mold. Such suspension of thermoforming cycles was available with plug-assistance whereby a mechanical plug pushed the center of the forming sheet and could be designed to hold the partly formed sheet in place above but not touching the cool mold.

Sample 147-1 2× (0 seconds delay) of Table 8 and Sample 156-9 2× of Table 3 were analyzed by x-ray and the results are shown in Table 9.

TABLE 9

| | Intensity Values | | | | | | | | | | |
|---|---|---|---|---|---|---|---|---|---|---|---|
| | | | D | | | | | | | | |
| | | B | M | E | F | H | I | J | K | L | |
| | A | M broad | narrow | Unoriented | Unoriented | E broad | E narrow | Oriented | Oriented | Ratios = | |
| | M | peak | peak | amorphous | crystalline | peak | peak | amorphous | crystalline | J/(K + | Ratios = |
| Sample | base | height | height | (B − A) | (D − B) | height | height | (H − D) | (I − H) | F) | J/K |
| 147-1 0s | 2200 | 6400 | 7000 | 4200 | 600 | 7800 | 8200 | 800 | 400 | 0.8 | 2 |
| 156-9 3x | 2300 | 6500 | 7100 | 4200 | 600 | 7200 | 12000 | 100 | 4800 | 0.02 | 0.02 |

Table 9 shows that when the relative amount of amorphous oriented content was low, the article had low shrinkage. The crystallite size of Sample 156-9 2× was 10 nm and the sample had low haze.

1. An article comprising or produced from a composition wherein
the article is a thermoformed two-dimensional article having a surface area to thickness ratio greater than about 200:1 inch and optionally at least 10% crystallinity;
the composition comprises poly(hydroxyalkanoic acid), 0 to about 4%, based on the weight of the composition, of a nucleator, and optionally an impact modifier;
the nucleator includes one or more carboxylic acids or, if the composition comprises the ethylene copolymer, an alkyl ester of the carboxylic acid, alkyl amide of the carboxylic acid, or combinations thereof; and the carboxylic acid includes aromatic carboxylic acid, aliphatic carboxylic acid, polycarboxylic acid, aliphatic hydroxycarboxylic acid, or combinations of two or more thereof; and
the impact modifier includes an ethylene copolymer, a core-shell polymer, or combinations thereof in which the ethylene copolymer comprises repeat units derived from (a) ethylene; (b) one or more olefins of the formula CH₂═C(R³)CO₂R⁴, R³ is hydrogen or an alkyl group with 1 to 6 carbon atoms, and R⁴ is glycidyl; and optionally (c) one or more olefins of the formula CH₂═C(R¹)CO₂R², or carbon monoxide where R¹ is hydrogen or an alkyl group with 1 to 8 carbon atoms and R² is an alkyl group with 1 to 8 carbon atoms, such as methyl, ethyl, or butyl.

2. The article of claim 1 wherein the poly(hydroxyalkanoic acid) comprises repeat units derived from 6-hydroxyhexanoic acid, 3-hydroxyhexanoic acid, 4-hydroxyhexanoic acid, 3-hydroxyheptanoic acid, or combinations of two or more thereof and the nucleator is present in the composition from about 0.1 to about 4%.

3. The article of claim 1 wherein the poly(hydroxyalkanoic acid) comprises repeat units derived from hydroxyalkanoic acids having five or fewer carbon atoms and the nucleator is present in the composition from about 0.1 to about 4%.

4. The article of claim 3 wherein the poly(hydroxyalkanoic acid) comprises repeat units derived from glycolic acid, lactic acid, 3-hydroxypropionic acid, 2-hydroxybutyric acid, 3-hydroxybutyric acid, 4-hydroxybutyric acid, 3-hydroxyvaleric acid, 4-hydroxyvaleric acid, 5-hydroxyvaleric acid, or combinations of two or more thereof and the nucleator is present in the composition from about 0.5 to about 4%.

5. The composition of claim 4 wherein
the composition comprises the impact modifier; the poly(hydroxy-alkanoic acid) comprises poly(glycolic acid), poly(lactic acid), poly(hydroxy-butyric acid), poly(hydroxy-butyrate-valerate) copolymer, copolymer of glycolic acid and lactic acid, hydroxyvaleric acid, 5-hydroxyvaleric acid, or combinations of two or more thereof; the nucleator includes aliphatic, mono-functional carboxylic acid; and
the nucleator is present in the composition from about 0.5 to about 3%.

6. The article of claim 5 wherein the impact modifier comprises the ethylene copolymer; the poly(hydroxyalkanoic acid) comprises the poly(lactic acid) and the nucleator includes aliphatic, mono-functional carboxylic acid; and the nucleator is present in the composition from about 1 to about 4%.

7. The article of claim 6 wherein the ethylene copolymer comprises repeat units derived from ethylene, alkyl (meth)acrylate, and optionally glycidyl (meth)acrylate; the nucleator includes lauric acid, palmitic acid, stearic acid, behenic acid, erucic acid, oleic acid, linoleic acid, behenic acid, or combinations of two or more thereof; and the nucleator is present in the composition from about 1 to about 2%.

8. The article of claim 7 wherein the impact modifier comprises copolymer of ethylene, butyl acrylate, and glycidyl methacrylate.

9. The article of claim 7 wherein the nucleator is stearic acid or behenamide.

10. The article of claim 8 wherein the nucleator is stearic acid or behenamide.

11. The article of claim 1 further comprising the impact modifier.

12. The article of claim 11 wherein the impact modifier comprises repeat units derived from ethylene, butyl acrylate, and glycidyl methacrylate.

13. The article of claim 1 wherein the composition is a concentrated master batch comprising about 25 to about 50% of stearic acid, behenamide, or both and about 50 to about 75% of poly(hydroxyalkanoic acid).

14. The article of claim 10 wherein the composition is a concentrated master batch comprising about 25 to about 50% of stearic acid, behenamide, or both and about 50 to about 75% of poly(hydroxyalkanoic acid).

15. A process comprises contacting a poly(hydroxyalkanoic acid) composition or poly(hydroxyalkanoic acid) with, 0 to about 4%, based on the weight of the composition or the poly(hydroxyalkanoic acid), of a nucleator to produce a compound; thermoforming in a heated mold at a temperature of from about 50° C. to about 140° C. to produce a thermoformed article; heat setting the article; recovering the thermoformed article.

16. The process of claim 15 wherein the poly(hydroxyalkanoic acid) comprises poly(lactic acid); the nucleator is present in the composition or the poly(hydroxyalkanoic acid) from about 0.1 to about 4; the contacting is carried out at a temperature from about 60° C. to about 130° C.; the heat setting is carried out at about 90° C. to about 135° C. for about 1 to about 20 seconds; and the nucleator includes aliphatic, mono-functional carboxylic acid.

17. The process of claim 16 wherein the nucleator includes lauric acid, palmitic acid, stearic acid, behenic acid, erucic acid, oleic acid, linoleic acid, behenamide, or combinations of two or more thereof; the contacting is carried out at a temperature from about 65° C. to about 120° C.; the heat setting is carried out at about 90° C. to about 120° C. for about 1 to about 10 seconds; and the nucleator is present in the composition or the poly(hydroxyalkanoic acid) from about 0.5 to about 4%.

18. The process of claim 17 wherein the nucleator is stearic acid or behenamide; the contacting is carried out at a temperature from about 65° C. to about 90° C.; and the heat setting is carried out at about 90° C. to about 110° C. for about 1 to about 5 seconds.

19. The process of claim 18 wherein the heat setting is carried out in about 2 to about 4 seconds.

20. A composition comprising poly(hydroxyalkanoic acid), 0 to about 4%, based on the weight of the composition, of a nucleator, an optionally an impact modifier;
the poly(hydroxyalkanoic acid) further characterized by crystallite size less than 1000 nm, and ratio of amorphous oriented molecules of less than 1;
the nucleator includes one or more carboxylic acids or, if the composition comprises the ethylene copolymer, an alkyl ester of the carboxylic acid, alkyl amide of the carboxylic acid, or combinations thereof; and the carboxylic acid includes aromatic carboxylic acid, aliphatic carboxylic acid, polycarboxylic acid, aliphatic hydroxycarboxylic acid, or combinations of two or more thereof; and
the impact modifier includes an ethylene copolymer, a core-shell polymer, or combinations thereof in which the ethylene copolymer comprises repeat units derived from (a) ethylene; (b) one or more olefins of the formula CH₂═C(R³)CO₂R⁴, R³ is hydrogen or an alkyl group with 1 to 6 carbon atoms, and R⁴ is glycidyl; and optionally (c) one or more olefins of the formula CH₂═C(R¹)CO₂R², or carbon monoxide where R¹ is hydrogen or an alkyl group with 1 to 8 carbon atoms and R² is an alkyl group with 1 to 8 carbon atoms.
